(19) United States
(12) Patent Application Publication
(10) Pub. No.: US 2020/0301911 A1
(43) Pub. Date: Sep. 24, 2020

(54) ELECTRONIC CHRONOLOGY

(71) Applicant: CHRONTHAT, INC., Basking Ridge, NJ (US)

(72) Inventors: Theodore ECONOMY, Basking Ridge, NJ (US); William J. GOLDBERG, Basking Ridge, NJ (US); Darren MITCHELL, Basking Ridge, NJ (US)

(21) Appl. No.: 16/770,134

(22) PCT Filed: Dec. 10, 2018
(86) PCT No.: PCT/US2018/064660

§ 371 Date: Jun. 5, 2020

Related U.S. Application Data
(60) Provisional application No. 62/708,407, filed on Dec. 8, 2017.

(51) Int. Cl. G06F 16/23; G06Q 10/10; G06F 16/25; G06F 3/0484

(52) U.S. Cl. CPC G06F 16/2379; G06Q 10/1095; H04L 67/10; G06F 3/0484; G06F 16/252

(57) ABSTRACT

Systems and methods for creating, manipulating, and displaying a timeline of chronological events each linked to corresponding one or more electronic files are described. An event corresponding to a time or time range can be created. One or more electronic files can be linked to the event. The event linked to the one or more electronic files can be presented on a graphical timeline at the time or time range. The one or more electronic files are accessible through the event displayed on the graphical timeline.

### RELATED APPLICATION

This application claims priority to U.S. Provisional Application Ser. No. 62/708,407, filed Dec. 8, 2017, entitled “CHRONTHAT”. The entirety of this provisional application is hereby incorporated by reference for all purposes.

### TECHNICAL FIELD

The present disclosure relates generally to electronic chronology and, more specifically, to systems and methods for creating, manipulating, and displaying a graphical timeline of chronological events each linked to one or more corresponding electronic files.

### BACKGROUND

Timelines provide a visual tool, which can be used to present a chronology of events arranged in their order of occurrence in time. Many tools exist that claim to help users to create timelines, but these tools each rely on the user entering the events and arranging the events in their order of occurrence in time. Relying on the user to enter the events and arrange the events is at best time consuming and impractical, but at worst impossible. In the legal community, for example, timelines can be very persuasive, but can only be created based on one's memory of events, which may be fallible.

In the electronic age, electronic files are time stamped with dates of creation, access, and editing. The time stamping of these electronic files provides a new mechanism to create an infallible timeline with indisputable dates. Use of these electronic files to create a horizontal, visually appealing timeline may be quite difficult, however, because the electronic files often are saved in different formats, requiring different programs to open. Currently, electronic files can be listed sequentially based on a time stamp. Additionally, current timeline creation tools can create a graphical timeline of events arranged with respect to time. However, no tools exist that can link the electronic files to events in a graphical timeline, much less make the electronic files accessible through the event displayed on the graphical timeline.

### SUMMARY

In an aspect, the present disclosure can include a system that can create, manipulate, and display a graphical timeline of chronological events linked to corresponding electronic files. The system includes a non-transitory memory storing instructions and a processor that accesses the memory and executes the instructions. An event corresponding to a time or time range can be created. One or more electronic files can be linked to the event. The event linked to the one or more electronic files can be presented on a graphical timeline at the time or the time range. The one or more electronic files are accessible through the event displayed on the graphical timeline.

In another aspect, the present disclosure can include another system that can create, manipulate, and display a graphical timeline of chronological events linked to corresponding electronic files. The system includes a non-transitory memory storing instructions and a processor that accesses the memory and executes the instructions. An electronic file can be received from a user. Metadata associated with the electronic file can be extracted from the electronic file and stored in the non-transitory memory. An event linked to the electronic file can be generated based on at least a portion of the metadata. The event can then be presented on a graphical timeline and linked to the electronic file. The electronic file can be accessible through the event displayed on the graphical timeline.

In another aspect, the present disclosure can include a method for creating a graphical timeline of chronological events linked to corresponding electronic files. The following steps of the method can be executed by a system comprising a processor. An event corresponding to a time or time range can be created. One or more electronic files can be linked to the event. The event linked to the one or more electronic files can be presented on a graphical timeline at the time or time range. The one or more electronic files are accessible through the event displayed on the graphical timeline.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 is a diagram showing a system that can create, manipulate, and display a timeline of chronological events linked to corresponding electronic files in accordance with an aspect of the present disclosure;

FIG. 2 is a schematic diagram of a cloud-based system that can be used by the system in FIG. 1;

FIG. 3 is a process flow diagram illustrating a method for creating, manipulating, and displaying a graphical timeline of chronological events linked to corresponding electronic files in accordance with another aspect of the present disclosure;

FIG. 4 is a process flow diagram illustrating a method for adding a new electronic file to the graphical timeline created according to the method of FIG. 3 according to another aspect of the present disclosure;

FIG. 5 is a process flow diagram illustrating another method for creating, manipulating, and displaying a graphical timeline of chronological events linked to corresponding electronic files in accordance with a further aspect of the present disclosure; and

FIG. 6 is a graphic illustrating an example timeline of example events with electronic files accessed through some of the example events.

### DETAILED DESCRIPTION

### I. Definitions

Unless otherwise defined, all technical terms used herein have the same meaning as commonly understood by one of ordinary skill in the art to which the present disclosure pertains.

As used herein, the singular forms “a,” “an” and “the” can also include the plural forms, unless the context clearly indicates otherwise.

As used herein, the terms “comprises” and/or “comprising,” can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

As used herein, the terms “first,” “second,” etc. should not limit the elements being described by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the term “chronology” can refer to events arranged in their order of occurrence in time (e.g., in a timeline).

As used herein, the term “electronic chronology” can refer to electronic files that are linked to events, which are arranged in their order of occurrence in time (e.g., in a timeline).

As used herein, the term “timeline” can refer to a display of a list of events in a chronological order. As an example, a timeline can be a graphic showing a list of events corresponding to dates arranged in a chronological order. The term “graphical timeline” can be used interchangeably with “timeline”.

As used herein, the term “electronic file” can refer to computer resource for recording data discretely in computer-readable form within a non-transitory computer readable storage medium (e.g., a memory). For example, the electronic file can be a digital file (e.g., a picture file, a drawing file, a document file, etc.), a media file (e.g., an audio file, a video file, etc.), or the like.

As used herein, the term “metadata” can refer to information stored with an electronic file that can provide basic information about the electronic file. The basic information can include, for example, means of creation of the electronic file, purpose of the electronic file, time and date of creation of the electronic file, creator or author of the electronic file, location in a computer network where the electronic file was created, global position satellite (GPS) coordinates of where the electronic file was created, standards used in creation of the electronic file, size of the electronic file, quality of the electronic file, source of the electronic file, process used to create the electronic file, etc.

As used herein, the term “event” can refer to something that happened at a singular time or a range of times (e.g., the range can extend from start time to end time). For example, the event can be related to a legal case, a medical case, a human resources project, an accounting project, a statistics project, a history project, an education project, a news story, a family history, or the like.

As used herein, the term “link” can refer to a relationship between two things (e.g., two electronic files) that can be established to cross reference between the two things.

As used herein, the term “non-transitory” when used with memory, media, storage medium, or the like, can refer to any type of computer memory that is not a transitory signal.

As used herein, the term “cloud” can refer to a network of one or more remote computing devices (e.g., servers) designed to store and manage data, run applications, and/or deliver content or service.

As used herein, the term “module” can refer to a distinct unit that can perform a portion of a program and/or process. A plurality of modules can together form a program and/or process.

### II. Overview

File management applications can be used to manipulate and edit electronic files, but these applications cannot provide any simple, user friendly visualization platform to access the electronic files. In contrast, timeline creation tools can provide a user friendly visualization platform of a graphical timeline that shows a chronology of events, but these timeline applications cannot be used for file management. The present disclosure, at its core, links the file management capability of file management applications to the user friendly visualization platform of the graphical timeline provided by timeline creation tools.

The systems and methods described herein can, for any subject, distill the subject into events (and/or allow the user to create events), link one or more electronic files to the events, and then present the events linked to the one or more electronic files to the user in a user-friendly fashion. For example, the events linked to the one or more electronic files can be displayed in a graphical timeline. The one or more electronic files can be accessible (e.g., viewable, playable, zoomable, scrollable, or the like) to the user by clicking on the event. Additionally, the graphical timeline can be displayed as a horizontal timeline, which can be zoomed in/out and scrolled horizontally (left/right). The systems and methods described herein can allow one to some out to see years of high level events, yet zoom in (by expanding the timeline) to the finest time resolution down to milliseconds or finer, while the related electronic files stay exactly in the same relative position with respect to time.

### III. Systems

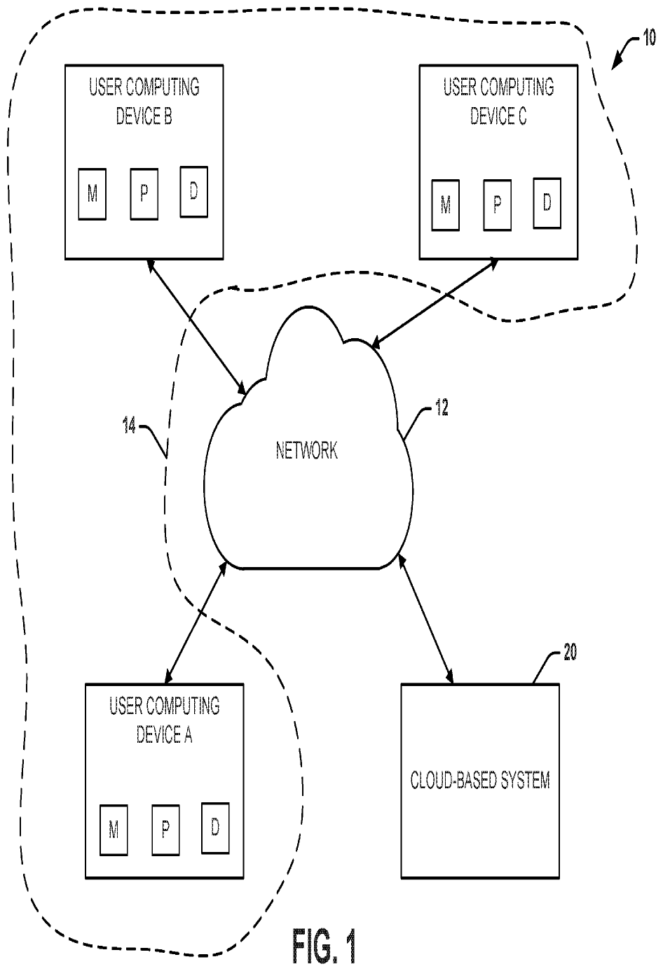

One aspect of the present disclosure can include a system 10 (FIG. 1) that can create, manipulate, and display a graphical timeline of chronological events linked to corresponding electronic files. The graphical timeline can provide a visualization of a chronology of various events (and this visualization can be zoomed in or out, shifted in time, or the like without affecting the overall graphical timeline). In addition to a visualization of the chronology, the graphical timeline can provide a user-friendly mechanism to access one or more electronic files associated with the various events. With the electronic files being accessible through the graphical timeline, users can view, play, zoom, scroll through, or provide any other function related to the electronic files right from the graphical timeline. The graphical timeline can be thought of as a new way to provide access to data—instead of a traditional vertical listing of electronic files, the graphical timeline provides a user-friendly horizontal display of events from which the electronic files can be accessed.

The system 10 can include a cloud-based system 20 and one or more user computing devices 14 (e.g., user computing device A-C, which can be smart phones, tablet computing devices, smart watches, laptop computers, desktop computers, or the like) connected to a network 12. Each of the one or more user computing devices 14 can include at least non-transitory memory (M), a processor (P), and a display (D). As an example, the display (D) can include a graphical user interface that facilitates display and interaction with the graphical timeline. Each of the one or more user computing devices 14 can also include one or more components (e.g., a transmitter, a receiver, a transceiver, or the like) that facilitate communication across the network 12. The one or more user computing devices 14 can be located in a common location and/or in different locations. The network 12 can be implemented as a public network (e.g., a wide area network, such as the Internet), a private network (e.g., a local area network), or a combination of a public network and a private network. The cloud-based system 20 can include one or more computing devices that are accessible to the one or more user computing devices 14 through the network 12.

The cloud-based system 20 can gather electronic files and corresponding metadata, organize the electronic files, and provide the graphical timeline with events at various times or time ranges corresponding to one or more electronic files. In other words, for any subject in need of such a graphical timeline, the cloud-based system can distill the subject into events (and/or allow the user of a particular user computing device to create events), link one or more electronic files (provided by the one or more user computing devices 14) to the events, and then present the events linked to the one or more electronic files to the user in a user-friendly fashion. The graphical timeline can be a browser-based horizontal technology that displays events linked to one or more electronic files to provide access to the one or more electronic files in an effective and interactive way, while being simple to create and visually stimulating.

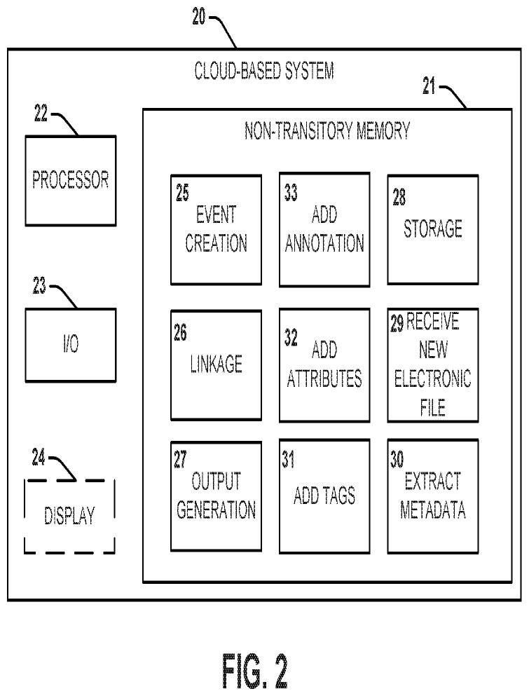

The cloud-based system 20, which can gather electronic files related to the graphical timeline, organize the electronic files and the graphical timeline, and present the graphical timeline, is shown in greater detail in FIG. 2. It should be understood that although the cloud-based system 20 is illustrated in FIG. 2 as a single computing device (e.g., a single server), the cloud-based system 20 can actually include a plurality of computing devices (at the same location or at distributed locations) each including at least a portion of FIG. 2. The cloud-based system 20 can include at least one non-transitory memory 21, at least one processor 22 (or processing resource), at least one I/O 23, and, optionally, at least one traditional display 24. The non-transitory memory 21 can store machine-executable instructions and electronic data. Examples of the non-transitory memory 21 can include volatile memory (e.g., RAM), nonvolatile memory (e.g., a hard disk, a flash memory, a solid state drive, or the like), or a combination of both. The processor 22 can include one or more processing cores, for example, which can access the non-transitory memory 21 and implement functionality of the cloud-based system 20. The I/O 23 can provide for communication with the one or more user computing devices 14 and/or other devices (e.g., other servers within the cloud-based system 20) through the network 12. The I/O 23 can, for example, receive electronic files as inputs and provide a graphical timeline with accessible electronic files as output.

Within the non-transitory memory 21, various modules can be stored. For example, an event creation 25 module can create or access an event corresponding to a time or a time range. A linkage 26 module can link one or more electronic files to the event. The linkage 26 module can link the one or more electronic files to the event based on information included in metadata associated with the one or more electronic files. For example, the metadata can include information about a creation time or edit time and the linkage 26 module can match the time within the metadata to a time or time range associated with the event. An output generation 27 module can present the event linked to the one or more electronic files at the time or time range on a graphical timeline. The one or more electronic files can be accessible through the event displayed on the graphical timeline.

The non-transitory memory 21 can include a storage 28 module to store the one or more electronic files. Each of the electronic files can be stored in connection with metadata, one or more tags, a user identifier (e.g., a person or entity), and/or one or more annotations. The metadata, one or more tags, user identifier, and/or one or more annotations can be used to search for the one or more electronic files and/or to match the one or more electronic files with a corresponding event. For example, the storage 28 can include a library or other storage mechanism in which a plurality of electronic files can be stored regardless of format. In some instances, at least a portion of the plurality of one or more electronic files can be converted to a format common to other one or more electronic files. As an example, different text documents in the form of email messages and documents can be saved in a common format, like Adobe PDF. The storage 28 module can also provide security to the electronic files (e.g., encryption), governing the users permitted to view, edit, annotate, and/or access the electronic files (e.g., different levels of authentication/access can be provided based on login credentials so that different users can have different levels of access to different subsets of the electronic files).

When another electronic file (e.g., any type of digital content, media content, or the like) is received through the I/O 23 at the receive new electronic file 29 module, the other electronic file can be saved in the storage 28 module. Metadata can be mined from the new file and stored with the new file in the storage 28 module. At the time of storage or at a later time, one or more tags, a user identifier (e.g., a person or entity), and/or one or more annotations can be associated with the other electronic file in the storage 28 module. The linkage 26 module can link the other electronic file to the event or another event based on metadata associated with the other electronic file, such that the other electronic file is accessible through the event or the other event through the event or the other event displayed on the graphical timeline. The event and the other event can be displayed chronologically on the graphical timeline according to the associated time or time range. The I/O 23 can output the graphical timeline to one or more of the user computing devices 14 so that the electronic file is accessible through the corresponding event on the graphical timeline.

In some instances, new events can be generated based on one or more electronic files. The metadata, tags, user identifier, and/or annotations associated with the one or more files can cause the cloud-based system 20 to generate a new event. As an example, metadata associated with an electronic file can be used to automatically generate a new time-specific event. The new time-specific event can be presented on the graphical timeline with the one or more electronic files accessible through the new time-specific event.

The non-transitory memory can include modules to be used in connection with the one or more electronic files. An extract metadata 30 module can be used to extract or separate the metadata from the one or more electronic files. An add tags 31 module can facilitate the addition of tags to the one or more electronic files. The tags can be standard tags (common to the subject) and/or user-defined tags. The user-defined tags can include any text-based identifier for the one or more electronic files. For example, a tag “airplane” can be added (either by a user or automatically) to one or more electronic files having a relationship to the design of a Boeing 737 airplane. As another example, a tag “2015 accounting” can be added (either by a user or automatically) to one or more electronic files having a relationship to purchases made during 2015. An electronic file related to the purchase of a Boeing 737 airplane in 2015 can be associated with both the “airplane” and “2015 accounting” tags. The add tags 31 module can also associate a person and/or an entity with the one or more electronic files. The person can be either a person who uploaded the electronic file and/or the person within and/or mentioned within the electronic file and/or have any relevance to the electronic file. For example, the electronic file can be uploaded by John Doe, but the electronic file can be an email from John Doe to Jane Smith; in this instance, electronic file can be associated with both John Doe and Jane Smith. Using the same example, the electronic file uploaded by John Doe can also be associated with an entity that employs John Doe and/or Jane Smith (like the Acme Company). An add attributes 32 module can facilitate the addition of one or more attributes to the electronic file. The one or more electronic files can be filterable according to the tags and/or the attributes. For example, when searching the storage 28, a query can be generated for 2015 accounting and Acme Company, and all files with both the tag “2015 accounting” and “Acme Company” will be provided as results.

An add annotation 33 module can be used to add annotations to the one or more electronic files. Notably, the add annotation 33 module can provide an additional layer of the one or more electronic files for annotations to be made. This allows the original one or more electronic files to remain intact when annotations are made on the one or more electronic files. The add annotation 33 module can provide a request prompting a user to add an annotation to the electronic file. The add annotation 33 module can receive the annotation in response to the request. The annotation can be saved, as described, as an additional layer associated with the one or more electronic files.

### IV. Methods

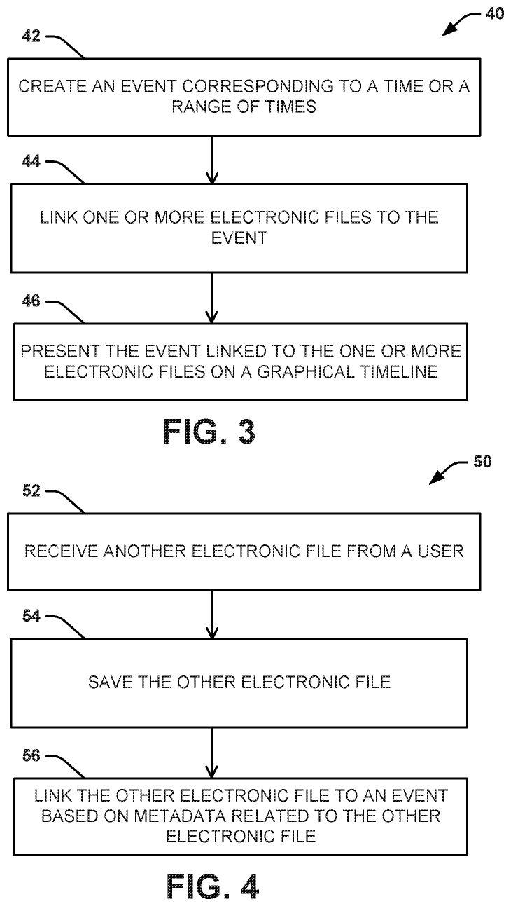

Another aspect of the present disclosure can include methods 40, 50, and 60 (FIGS. 3, 4, and 5) for creating, manipulating, and displaying a graphical timeline of chronological events linked to corresponding electronic files. The graphical timeline can be thought of as a new way to provide access to data—instead of a traditional vertical listing of electronic files, the graphical timeline provides a user-friendly horizontal display of events from which the electronic files can be accessed. The methods 40, 50, and 60 can be executed using the system 10 shown in FIG. 1 and/or the cloud-based system 20 shown and described above.

The methods 40, 50, and 60 are illustrated as process flow diagrams with flowchart illustrations. For purposes of simplicity, the methods 40, 50, and 60 are shown and described as being executed serially; however, it is to be understood and appreciated that the present disclosure is not limited by the illustrated order as some steps could occur in different orders and/or concurrently with other steps shown and described herein. Moreover, not all illustrated aspects may be required to implement the methods 40, 50, and 60.

Referring now to FIG. 3, illustrated is a method 40 for creating, manipulating, and displaying a graphical timeline of chronological events linked to corresponding electronic files. The graphical timeline can provide a visualization of a chronology of various events (and this visualization can be zoomed in or out, shifted in time, or the like without affecting the overall graphical timeline). In addition to a visualization of the chronology, the graphical timeline can provide a user-friendly mechanism to access one or more electronic files associated with the various events. With the electronic files being accessible through the graphical timeline, users can view, play, zoom, scroll through, or provide any other function related to the electronic files right from the graphical timeline.

At 42, an event corresponding to a time or a range of times can be created (e.g., by the event creation 25 module of the cloud-based system 20). For example, the event corresponding to a time can be receipt of an email. As another example, an event corresponding to a range of times can be a length of employment. The receipt of the email can be a singular point during the length of employment. At 44, one or more electronic files can be linked to the event (e.g., by the linkage 26 module of the cloud-based system 20). The link can be created based on one or more tags, a user identifier (e.g., a person or entity), and/or one or more annotations associated with the one or more electronic files. For example, the contents of the email, as well as any attachments, can be linked to the event “receipt of the email” based on one or more tags, a user identifier (e.g., a person or entity), and/or one or more annotations associated with the email. At 46, the event linked to the one or more electronic files can be presented on the graphical timeline (e.g., by the output generation 27 module of the cloud-based system 20).

FIG. 4 illustrates a method 50 that extends the method 40 with regard to another electronic file. At 52, another electronic file can be received from a user (e.g., by the receive new electronic file 29 module of the cloud-based system 20). Alternatively, the other electronic file can be retrieved from a location as per an instruction from a user and/or automatically. At 54, the other electronic file can be saved (e.g., in the storage 28 module of the cloud-based system 20. The other electronic file can be associated with one or more tags, a user identifier (e.g., a person or entity), and/or one or more annotations. At 56, the other electronic file can be linked (e.g., by the linkage 26 module of the cloud-based system 20) to an event based on metadata related to the other electronic file. However, the linkage can also be based on one or more tags, a user identifier (e.g., a person or entity), and/or one or more annotations associated with the other electronic file.

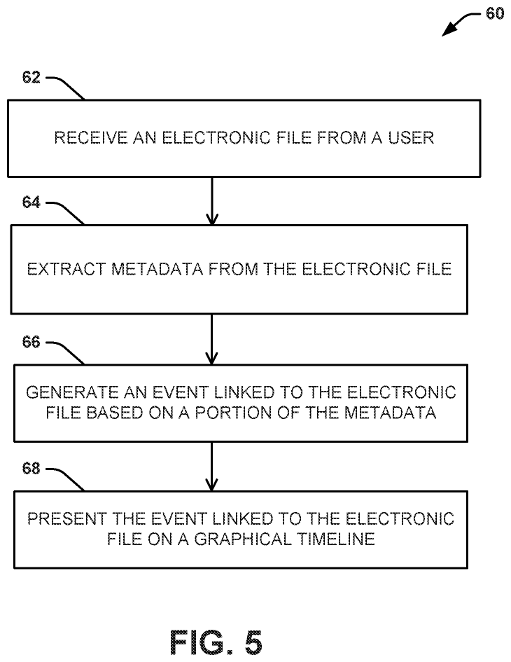

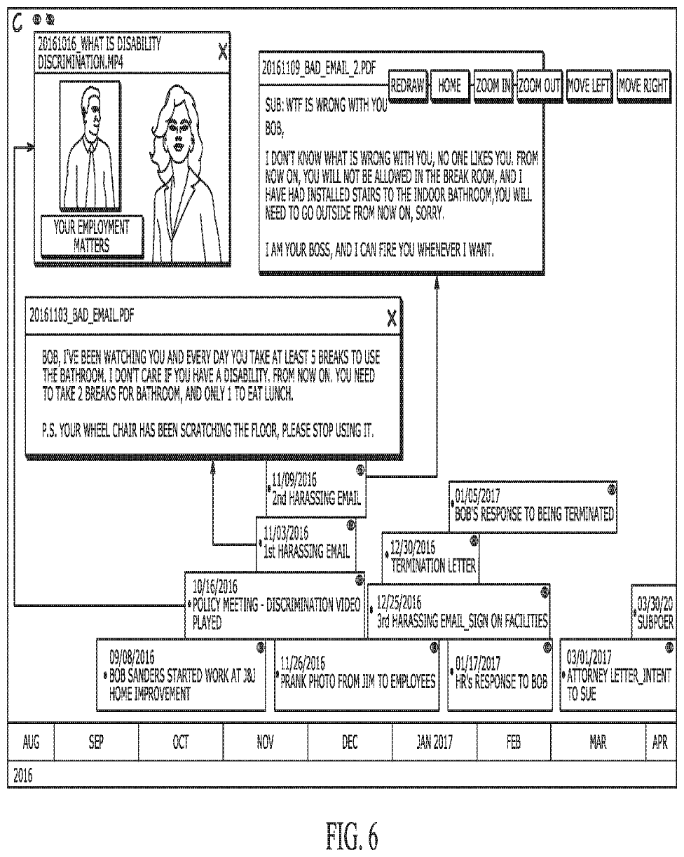

Referring now to FIG. 5, illustrated is another method 60 for creating, manipulating, and displaying a graphical timeline of chronological events linked to corresponding electronic files. At least a portion of the method 60 automatically conducted by the cloud-based system 20. At 62, an electronic file can be received (e.g., by the receive new electronic file 29 module of the cloud-based system 20) from a user. At 64, metadata can be extracted (e.g., by the extract metadata 30 module of the cloud-based system 20) from the electronic file. At 66, an event can be generated (e.g., by the event creation 25 module of the cloud-based system 20) and linked to the electronic file (e.g., by the linkage 26 module of the cloud-based system 20) based on at least a portion of the metadata. At 68, the event linked to the electronic file can be presented on a graphical timeline. The electronic file can be accessed from the event on the graphic timeline.

### V. Example

The systems and methods described herein can be used in connection with any number of subjects. For example, subjects for which a graphical timeline can be built a wide-ranging—from legal, to fitness to science, to photos, to games, to government, to life, to finance, to kids, to accounting, to history, to education, to human resources, to social events, to law enforcement, to weather, to medicine, to compliance, to production, to ancestry, to family, to compliance, to statistics, to news, to health, or anything in between. FIG. 5 shows an example timeline that can be presented in a browser-based horizontal technology that can be used in the legal field to show electronic files and dates related to a case regarding Bob Sanders' employment discrimination. The example timeline provides an organized case chronology presented in a clear and comprehensive fashion for the legal case.

Bob Sanders' employment at J&J Home Improvement, which started on Sep. 8, 2016 and ended on Dec. 30, 2016, is shown as an event on the graphical timeline. Events that happened during his employment and after his employment are shown on the timeline graphical corresponding to dates. Events that occurred after his employment was terminated are also shown on the graphical timeline.

Each of the events can be associated with corresponding electronic files that are accessible through the graphical timeline. As shown, three example electronic files are accessed from the events at three different dates: a discrimination video from a policy meeting held Oct. 16, 2016, a harassing email received Nov. 3, 2016, and another harassing email received Nov. 9, 2016. The arrows within FIG. 5 show the electronic files corresponding to the events. The electronic files can be supporting evidence for events that happened on the dates.

From the above description, those skilled in the art will perceive improvements, changes and modifications. Such improvements, changes and modifications are within the skill of one in the art and are intended to be covered by the appended claims.

The following is claimed:

1. A system comprising:
a non-transitory memory storing instructions; and
a processor that accesses the memory and executes the instructions to at least:
create an event corresponding to a time or time range;
link one or more electronic files to the event;
present the event linked to the one or more electronic files at the time or time range on a graphical timeline, wherein the one or more electronic files are accessible through the event displayed on the graphical timeline.

2. The system of claim 1, wherein the processor executes the instructions to:
receive another electronic file from a user; and
link the other electronic file to the event based on at least a portion of metadata associated with the other electronic file,
wherein the other electronic file is accessible through the event displayed on the graphical timeline.

3. The system of claim 2, wherein the processor executes the instruction to convert the other electronic file into a format common to the one or more electronic files.

4. The system of claim 1, wherein the processor executes the instructions to:
create another event corresponding to another time or time range;
link one or more additional electronic files to the other event;
present the other event linked to the one or more additional electronic files at the other time or time range on a graphical timeline, wherein the additional electronic file is accessible through the other event displayed on the graphical timeline.

5. The system of claim 1, wherein the processor further executes the instructions to send to the graphical timeline for display within a graphical user interface by a display device,
wherein the graphical user interface facilitates interaction with the graphical timeline by an entity associated with the display device, and
wherein the interaction is at least one of expanding the graphical timeline, contracting the graphical timeline, annotating the electronic file associated with the event, deleting the electronic file associated with the event and deleting the electronic file associated with the event from the timeline.

6. A system comprising:
a non-transitory memory storing instructions; and
a processor that accesses the memory and executes the instructions to at least:
receive an electronic file from a user;
extract metadata associated with the electronic file from the electronic file, wherein the metadata is stored in the non-transitory memory;
generate an event linked to the electronic file based on at least a portion of the metadata; and
present the event linked to the electronic file on a graphical timeline, wherein the electronic file is accessible through the event displayed on the graphical timeline.

7. The system of claim 6, wherein the processor executes the instructions to:
receive another electronic file;
extract other metadata associated with the other electronic file;
generate another event linked to the other electronic file based on at least a portion of the other metadata.

8. The system of claim 7, wherein the processor further executes the instructions to convert the electronic file and the other electronic file into a common format.

9. The system of claim 7, wherein the other event linked to the other electronic file is presented on the graphical timeline with the event linked to the electronic file in a horizontal fashion based on a date associated with the other metadata and a date associated with the metadata.

10. The system of claim 6, wherein the processor further executes the instructions to send the graphical timeline for display within a graphical user interface by a display device,
wherein the graphical user interface facilitates interaction with the graphical timeline by an entity associated with the display device, and
wherein the interaction is at least one of expanding the graphical timeline, contracting the graphical timeline, annotating the electronic file associated with the event, deleting the electronic file associated with the event and deleting the electronic file associated with the event from the timeline.

11. The system of claim 6, wherein the processor further executes the instructions to assign a tag, a person, and/or an entity to the electronic file,
wherein a plurality of electronic files are filterable according to an associated tag, person, and/or entity.

12. The system of claim 11, wherein the processor further executes the instructions to apply attributes to the electronic file,
wherein the plurality of electronic files are further filterable according to an associated attribute.

13. The system of claim 6, wherein the processor further executes the instructions to:
receive an annotation associated with the electronic file; and
save the annotation as a layer associated with the electronic file.

14. The system of claim 13, wherein the annotation is received in response to a request to annotate the electronic file.

15. A method comprising:
creating, by a system comprising a processor, an event corresponding to a time or time range;
linking, by the system, one or more electronic files to the event;
presenting, by the system, the event linked to the one or more electronic files at the time or time range on a graphical timeline, wherein the electronic file is accessible through the event displayed on the graphical timeline.

16. The method of claim 15 further comprising:
receiving, by the system, another electronic file from a user; and
saving, by the system, the other electronic file in a library common with the one or more electronic files and/or in a common format with the one or more electronic files;
linking, by the system, the other electronic file to the event based on at least a portion of metadata associated with the other electronic file,
wherein the other electronic file is accessible through the event displayed on the graphical timeline.

17. The method of claim 15, further comprising:
creating, by the system, another event corresponding to another time or time range;
linking, by the system, one or more additional electronic files to the other event;
presenting, by the system, the other event linked to the one or more additional electronic files at the other time or time range on a graphical timeline, wherein the additional electronic file is accessible through the other event displayed on the graphical timeline.

18. The method of claim 15, further comprising displaying the graphical timetable on a graphical user interface associated with a display device,
wherein the graphical user interface facilitates interaction with the graphical timeline by an entity associated with the display device, and
wherein the interaction is at least one of expanding the graphical timeline, contracting the graphical timeline, annotating the electronic file associated with the event, deleting the electronic file associated with the event and deleting the electronic file associated with the event from the timeline.

19. The method of claim 15, wherein the one or more electronic files are each associated with:
one or more tags, persons, and/or entities, and/or
one or more attributes.

20. The method of claim 19, wherein the one or more electronic files are filterable based on the associated one or more tags, persons, and/or entities and/or the associated one or more attributes.
